(19) United States
(12) Patent Application Publication
(10) Pub. No.: US 2002/0046019 A1
(43) Pub. Date: Apr. 18, 2002

(54) Method and system for acquiring and maintaining natural language information

(75) Inventors: Marcus E. M. Verhagen, Somerville, MA (US); James D. Pustejovsky, Arlington, MA (US); Robert J.P. Ingria, Somerville, MA (US); Federica Busa, Somerville, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LingoMotors, Inc., Cambridge, MA

(21) Appl. No.: 09/898,987

(22) Filed: Jul. 3, 2001

Related U.S. Application Data
(60) Provisional application No. 60/226,413, filed on Aug. 18, 2000.

(51) Int. Cl. G06F 17/27

(52) U.S. Cl. 704/9

(57) ABSTRACT

According to the present invention, a technique including a method for acquiring natural language information is provided. In one embodiment, the present invention provides a method and system for generating and maintaining a combination of syntactic and semantic information objects. In another embodiment, the present invention provides a method and system for generating and maintaining semantic lexical items stored in a computer system. In yet another embodiment, the present invention provides a method and system for generating and maintaining types stored in a computer system.

### BACKGROUND OF THE INVENTION

This invention generally relates to the field of natural language information management. More particularly, the present invention provides techniques including a method and system for acquiring and maintaining natural language information.

The expansion of the Internet has proliferated “on-line” textual information. Such on-line textual information includes newspapers, magazines, WebPages, email, advertisements, commercial publications, and the like in electronic form. By way of the Internet, millions if not billions of pieces of information can be accessed using simple “browser” programs. Information retrieval (herein “IR”) engines such as those made by companies such as Yahoo! allow a user to access such information using an indexing technique. The indexing technique includes full-text indexing, in which content words in a document are used as keywords. Full text searching had been one of the most promising of recent IR approaches. Unfortunately, full text searching has many limitations. For example, full text searching lacks precision and often retrieves literally thousands of “hits” or related documents, which then require further refinement and filtering. Additionally, full text searching has limited recall characteristics. Accordingly, full text searching has much room for improvement.

Techniques such as the use of “domain knowledge” can enhance an effectiveness of a full-text searching system. Domain knowledge techniques often provide related terms that can be used to refine the full-text searching process. That is, domain knowledge often can broaden, narrow, or refocus a query at retrieval time. Likewise, domain knowledge may be applied at indexing time to do word sense disambiguation or simple content analysis. Unfortunately, for many domains, such knowledge, even in the form of a thesaurus, is either generally not available, or is often incomplete with respect to the vocabulary of the texts indexed.

There have been attempts to use natural language understanding in some applications. As merely an example, U.S. Pat. No. 5,794,050 in the names of Dahlgren et al. (herein Dahlgren.) utilized a conventional rule based system for providing searches on text information. Dahlgren, et al. use a naive semantic lexicon to “reason” about word senses. This simple semantic lexicon brings some “common sense” world knowledge to many stages of the natural language understanding process. Unfortunately, the design of such a semantic lexicon follows fairly standard taxonomic knowledge representation techniques, and hence the reasoning process making use of this taxonomy is generally incomplete. That is, it may provide a first level method for performing a relatively simple search, but often lacks a general ability to conduct a detailed retrieval to provide a comprehensive answer to a query. Fundamentally, the method and system described in Dahlgren, employs a natural language understanding system to provide a “concept annotation” of text for subsequent retrieval. Furthermore, when the system is used to query a database, it matches on pointers to the text provided by the annotation rather than an answer to the query.

Although some of the above techniques are fairly sophisticated compared to the information retrieval search engines so ubiquitous on the internet (e.g., Inktomi or Alta Vista), the results of the queries are “hits” rather than “answers”; that is, a hit is the entire text that matches the indexing criteria, while an answer on the other hand is the actual utterance (or portion of the text) that satisfied a user query. For example, if the query were “Who are the officers of Microsoft, Inc?”, a hit-based system would return all the documents that contain this information anywhere within them, whereas an answer-based system would return the actual value of the answer, namely the officers.

From the above, it is seen that techniques for improved knowledge representation and information retrieval is highly desirable.

### SUMMARY OF THE INVENTION

According to the present invention, a technique including a method for acquiring natural language information is provided. In one embodiment, the present invention provides a method and system for generating and maintaining a combination of syntactic and semantic information objects. In another embodiment, the present invention provides a method and system for generating and maintaining semantic lexical items stored in a computer system. In yet another embodiment, the present invention provides a method and system for generating and maintaining types stored in a computer system.

In one embodiment of the present invention a method using a computer system for determining semantic information of a lexical unit is provided. The method includes lexical unit being received by the computer system; determining a stem and type of the lexical unit and generating semantic information associated with the lexical unit, where the semantic information is based on the stem and the type.

Another embodiment provides a method for generating a semantic lexical item from an input, including: receiving the input by a computer; determining category information, stem and type of the input; and generating the semantic lexical item associated with said stem, where the semantic lexical item, includes said type and said category information.

A further embodiment provides a method for displaying a stage in the natural language compilation of an utterance, including receiving the utterance by a natural language system; determining a semantic item associated with the utterance; and displaying the semantic item.

These and other embodiments of the present invention are described in more detail in conjunction with the text below and attached Figs.

### BRIEF DESCRIPTION OF THE DRAWINGS

FIG. to. 1 illustrates a simplified block diagram of an embodiment of the present invention.

FIG. 2 shows a simplified type structure of one embodiment of the present invention.

FIG. 3 illustrates the major types of an embodiment of the present invention.

FIG. 4 illustrates an example of a complex entity of an embodiment of the present invention.

FIG. 5 illustrates an example of a simple event, for example verb, of an embodiment of the present invention.

FIG. 6a has a block diagram illustrating the creation of a new type in one embodiment of the present invention.

FIG. 6b the has a block diagram illustrating the creation of a new semantic lexical item in an embodiment of the present invention.

FIG. 7 illustrates an example of a tool palette of an embodiment of the present invention.

FIG. 8 illustrates an example of a using multiple inheritance to create a new type in an embodiment of the present invention.

FIG. 9 illustrates one instance of a type creator window for adding a type to the type tree in one embodiment of the present invention.

FIG. 10 shows the results of adding a complex entity type in one embodiment of the present invention.

FIG. 11 shows an example of creating a simple type of an embodiment of the present invention.

FIG. 12 shows the results of adding a simple entity type in one embodiment of the present invention.

FIG. 13 illustrates the process of modifying a type characteristic, for example, quale, of an embodiment of the present invention.

FIG. 14 illustrates the results of modifying a characteristic of FIG. 13.

FIG. 15 shows the selection of a category for a lexical entry of one embodiment of the present invention.

FIG. 16 shows the entry of a noun lexical entry of one embodiment of the present invention.

FIG. 17 shows a new lexical semantic unit created for the stem of FIG. 16 of one embodiment of the present invention.

FIG. 18 shows the entry of a stem for a verb entry of one embodiment of the present invention.

FIG. 19 illustrates the addition of VerbEntry characteristics to a verb stem of an embodiment of the present invention.

FIG. 20 illustrates modifying the argument structure of an Event of an embodiment of the present invention.

FIG. 21 shows the results of semantic information associated with a stem of an adjective entry of an embodiment of the present invention.

FIG. 22 illustrates adding AdjectiveEntry characteristics to the stem of an embodiment of the present invention.

FIGS. 23 to 26 illustrate the use of the Sage Tracer/Debugger 726 (FIG. 7) in the populate mode for an example utterance, “recipes for soup,” for one embodiment of the present invention.

FIG. 23 illustrates the pre-processing section of the tracer/debugger for an utterance of an embodiment of the present invention.

FIG. 24 illustrates the parses section of the tracer/debugger for one word of an utterance of an embodiment of the present invention.

FIG. 25 illustrates the parses section of the tracer/debugger for another word of an utterance of an embodiment of the present invention.

FIGS. 26a to 26b show the parse trace section for an example utterance “recipes for soup” of a specific embodiment of the present invention.

FIG. 27 illustrates a semantic item, EntityLexLF, for an example utterance “recipes for soup” of a specific embodiment of the present invention.

FIG. 28 illustrates a parse tree for an EntityLexLF, for an example utterance “recipes for soup” of a specific embodiment of the present invention.

FIG. 29 illustrates edges in a parse tree for a word in an example utterance “recipes for soup” of a specific embodiment of the present invention.

FIG. 30 illustrates a use of the tracer/debugger in the query a mode for a sample utterance of an embodiment of the present invention.

FIG. 31 illustrates the selected edges section of the tracer/debugger in query mode for an example utterance of an embodiment of the present invention.

### DESCRIPTION OF THE SPECIFIC EMBODIMENTS

FIG. to. 1 illustrates a simplified block diagram of an embodiment of the present invention. An engine 112 includes a tokenizer 210, a tagger 212, a stemmer 214, and an interpreter 220. The engine 112 through its interpreter 220 receives information from the knowledge resources 114. The interpreter includes a lexical look-up 222 and a syntactic-semantic composition 224. The knowledge resources include a lexicon 230 interacting with a type system 232, and grammar rules and roles 234.

The tokenizer 210 takes a text stream composed of punctuation, words, and numbers from a user query (not shown) or a customer corpus 110 and creates tokenized elements. The tokenizer performs this procedure by first dividing the text into subparts of orthographic words which are unbroken sequences of alphanumeric characters delimited by white space; next, grouping the orthographic words into sentences; and then separating punctuation from words, except where the punctuation should remain part of the word like in abbreviations.

The tagger 212 then attaches to each tokenized element a grammatical category or part of speech label based on the Brill ruled-based tagging algorithm. The tagger 212 uses a tag dictionary which has a master list of words with tags. The lexical rules provide a means for the tagger 212 to guess a word and contextual rules provide a means to interpret words and tags according to context.

Next the stemmer 214 provides a system name to be used for retrieval for each labeled/tokenized element. The stemmer 212 creates a root form and assigns a numeric offset designating the position in the original text. The stemmer 214 uses a stem dictionary which is a master list of stems.

The interpreter 220 translates the part of speech labels of the tagger 212 into fully specified syntactic categories and uses these new categories with the lexical lookup form of the stemmer 214 to see if the stem already exists in the knowledge resources 114. If the stem exists, the syntactic and semantic information in the lexical entry, for example word, is added to the syntactic category. If the stem is unknown, the interpreter adds default information. The lexical lookup form using, for example, the word's stem, is done by the lexical lookup 222 which interacts with a lexicon 230 and a type system 232. The lexicon 230 has syntactic concepts and includes a file for each part of speech. The type system 232 has semantic concepts.

The interpreter 220 also parses (assembles syntactic compositions out of) these categories by applying the grammar rules to combine them into larger syntactic constituents. By applying the grammar rules and the grammar roles 234, and the output of the lexical lookup 222, the interpreter makes a syntactic-semantic composition 224 as it parses. The resulting syntactic-semantic composition 224 is the meaning of the input text stream. This is then output from the engine 112 at node B 128.

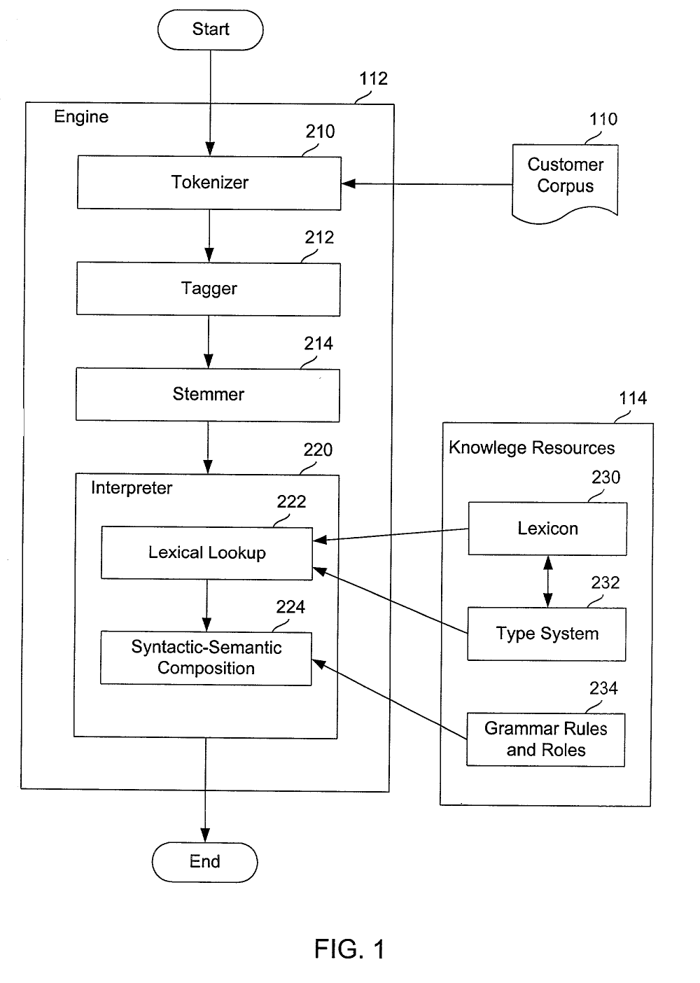

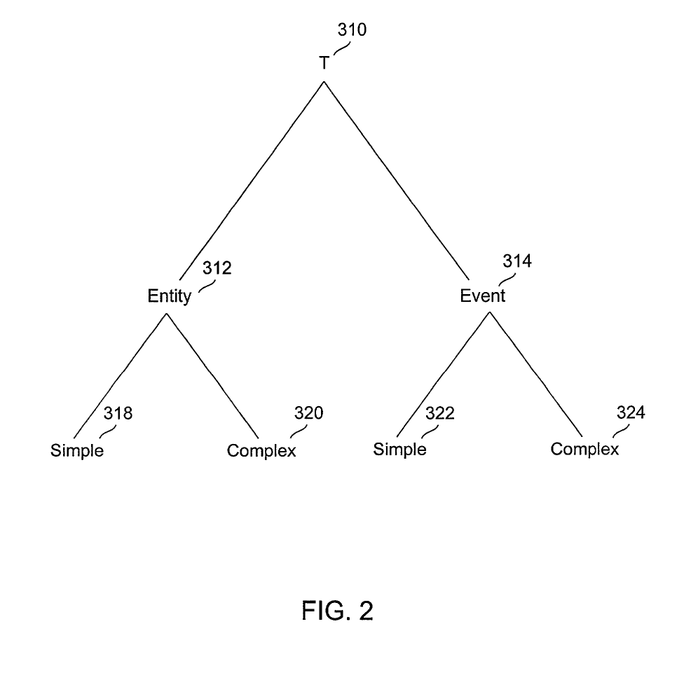

The system described in FIG. 2 is covered in detail in U.S. patent application Ser. No. 09/449,845 in the names of James D. Pustejovsky, et al. titled, “A Natural Knowledge Acquisition System,”, filed Nov. 26, 1999, which is herein incorporated by reference in its entirety.

FIG. 2 shows a simplified type structure of one embodiment of the present invention. This bipartite type structure has a root of “T” 310, which represents the TopType. The first level under root 310 includes entity 312, for example, nouns, and event 314, for example, verbs and adjectives. Entity type 312 then has simple types 318 and complex types 320. Event type 314 has simple types 322 and complex types 324.

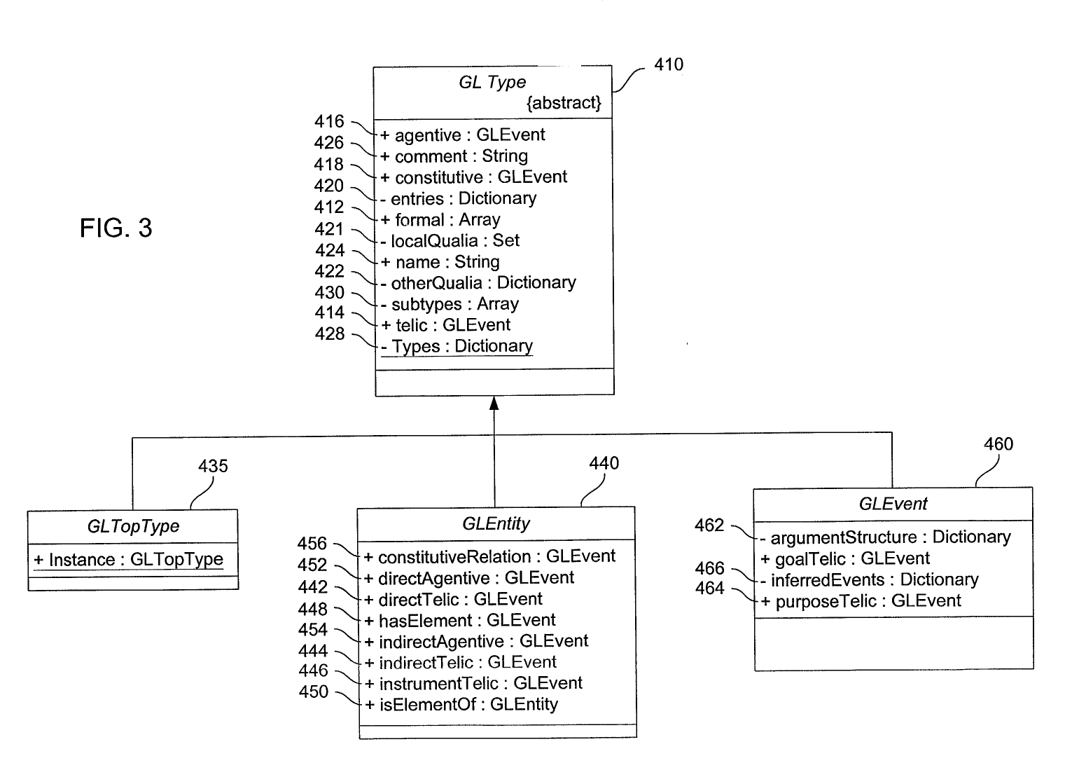

FIG. 3 illustrates the major types of an embodiment of the present invention. The root of the class hierarchy that implements the type system 232 is given by class GLType 410(an Abstract Class). GLType has three subclasses: first, GLTopType 435, whose sole instance is the root of the objects (instances) that make up the type system; second, GLEntity 440 for entities, which typically represents the semantics of nouns; and third, GLEvent 460 for events, which typically represents the semantics of verbs and adjectives. The subclasses GLEntity 440 and GLEvent 460 inherit characteristics, for example, data members (instance variables) and member functions (methods), from the parent class, GLType 410. Inheritance as used in object oriented programming is used throughout the type structure.

GLType 410 provides the system template for an abstract characterization of meanings of words, and it includes the following instance variables:

A. Formal 412: an Array. The Formal provides a unique identity. The Formal establishes the type/subtype relation between types and provides the key for doing inheritance.

B. The following instance variables are optional and may or may not be filled in any given instance of GLType:

1. Telic (GLEvent) gives the purpose or function. What do I do? What am I for?

2. Agentive (GLEvent) gives creative factors: How do I come about?

3. Constitutive (GLEvent) gives a relationship to parts, and is instantiated by one of the two complementary relations:

a. HasElement: I have a part of which a group is made.

b. IsElementOf: I am a part of another.

4. Entries (Dictionary) 420 are words associated with this one in the Lexicon 230; i.e. entries contains all the lexical entries that have this particular instance of GLType as their specified type.

5. LocalQualia (Set) 421 and otherQualia (Dictionary) 422 are qualia in addition to formal, constitutive, agentive, and telic and are an open-ended possibility. OtherQualia specifies which of these additional qualia a given instance of GLType contains. LocalQualia specifies which of these additional qualia are defined on the particular instance; qualia that appear in OtherQualia but not in LocalQualia were inherited from a parent of the instance.

6. Name 424: (String) name of the given instance of GLType.

7. Comment 426: (String): notes by the knowledge engineer about non-typical features of the type.

8. Subtypes 430 (Array): system generated list of children In one embodiment, for each GLEntity, there may be one or more of the above qualia (formal is required) but only one of each kind.

In addition to the above instance variables (data members), the class GLType itself contains the class variable (static data member) Types 428 (Dictionary): which maps the name of each type to an actual instance of GLType. The contents of Types is system generated whenever a new type instance is created.

In a specific embodiment, instances of GLEntity 440 may include zero or more of the following qualia relations:

1. directTelic 442: (GLEvent) What do I do? The “subject” (external argument) of the GLEvent is the one being defined. For example: the GLEntity [[Music Artist]] (the type of the noun “musician”): has Formal [[Artist]] and DirectTelic [[Perform Music Activity]]; this represents the fact that a musician is a kind of artist who plays music.

2. indirectTelic 444: (GLEvent) What do you do to me? The “object” (internal argument) of the GLEvent is the one being defined. For example: the GLEntity [[Wind Instrument]] (the type of the noun “trumpet”, among others) has Formal: [[Musical Instrument]] and indirectTelic: [[Perform Music Activity]]; this represents the fact that a trumpet is something that one uses to perform music.

3. instrumentTelic 446: (GLEvent) What am I useful for? For example, the GLEntity [[Envelope]] (the type of the noun “envelope”) has instrumentTelic [[Contain Relation]].4. Constitutive hasElement 448: (GLEntity) I have a part of which a group is made. For example, [[Human Group]] (the type of the noun “crowd”, among others) hasElement [[Human]].

5. Constitutive isElementOf 450: (GL Entity) I am an inherent part of another. 2X For example, [[Hard-drive]] isElementOf [[Computer]].

6. DirectAgentive 452: (GLEvent) an external argument of the event specified—To what activity do I give rise? Example: a composer composes music; so [[Composer]] has the directAgentive [[Create Music Activity]].7. IndirectAgentive 454: (GLEvent)—What activity gives rise to me? For example: [[Write Activity]] is the indirectAgentive of [[Book]].

8. ConstitutiveRelation 456: (GL Event)—What is the relationship between the stuff I am made of and me?

9. Genre (not shown): a grouping of things that have something in common like dept. in a store, types of books, a category in a music store. For example, [[Singer]] has genre [[Music Genre]]; e.g. a jazz singer, a blues singer, etc. [[Linguist]] has genre [[Language Genre]]; e.g. a Greek linguist, a Sanskrit linguist, etc.

In a specific embodiment instances of GLEvent 460 include one or more of the following:

1. argumentStructure 462: (Dictionary) This is a required field that describes the semantic roles of the word and answers the question “How can I be used in a sentence?What complements can appear with me?”

2. purposeTelic 464: (GLEvent)-similar in function to the directTelic (what do I do) and indirectTelic (what do you do to me).

3. inferredEvents 466: (Dictionary) Specifies the additional events that can be inferred from the specified event. For example in the phrase: “I give the book to Mary”, the verb “give” induces the inferred event of possession; i.e. Mary now has the book she was given.

The argument structure 462 deals with the semantic roles of a word made available by its type by answering the question: “Where will you find each role in the sentence structure?” In one embodiment there are two categories of roles: Semantic roles that go into the Type System 232 and Grammatical relations that are properties of a lexical entry. Semantic roles include:

1. externalArgument: [[Entity]]: who does the action?

2. theme: [[Entity]]: who does it get done to?

3. goal: [[Entity]]: where does the theme go?

Grammatical relations indicate where binders of the semantics roles appear in phrases and clauses. These include roles such as:

1. Subject: e.g. “Mary bought the book.”

2. DirectObject: e.g. “Mary bought the book.”

3. ClauseRole: e.g. “The newspapers say that the stock is falling”; “I want to cook with my child.”. Associated with this role is the field clausalComp which specifies whether the clause contains an introductory “that”, “to”, etc.

PpRole1, PpRole2, and PpRole3 describe the semantic role that the object of a prepositional complement plays. Since there can be more than one prepositional complement to a verb (e.g. “I flew from Boston to New York”), multiple prepositional roles are available. And since prepositional complements are not structural roles like Subject and DirectObject (i.e. they need not appear in a given order; for example, “I flew to New York from Boston.”) each ppRole<n> has an associated ppHead<n>, which specifies the preposition that appears in the preposition with the role indicated. For example, for a verb like “fly”, “to” would indicate the goal, while “from” would indicate the origin.

An example of a simple entity 440 of FIG. 3 is GLEntity type [[Book]], which is the type of the noun “book.” It is a subtype of “Readable Representational Artifact”, as is indicated by its Formal quale. The simple entity structure for [[Book]] may look as follows:

Book (Books)

“a Simple GLEntity”
formal: #([[Readable Representational Artifact]])
indirectAgentive: [[Write Activity]]
directTelic: [[Describe Relation]]
indirectTelic: [[Read Activity]]
location: [[Locative Relation]]
genre: [[Genre]]
medium: [[Communication Medium]]

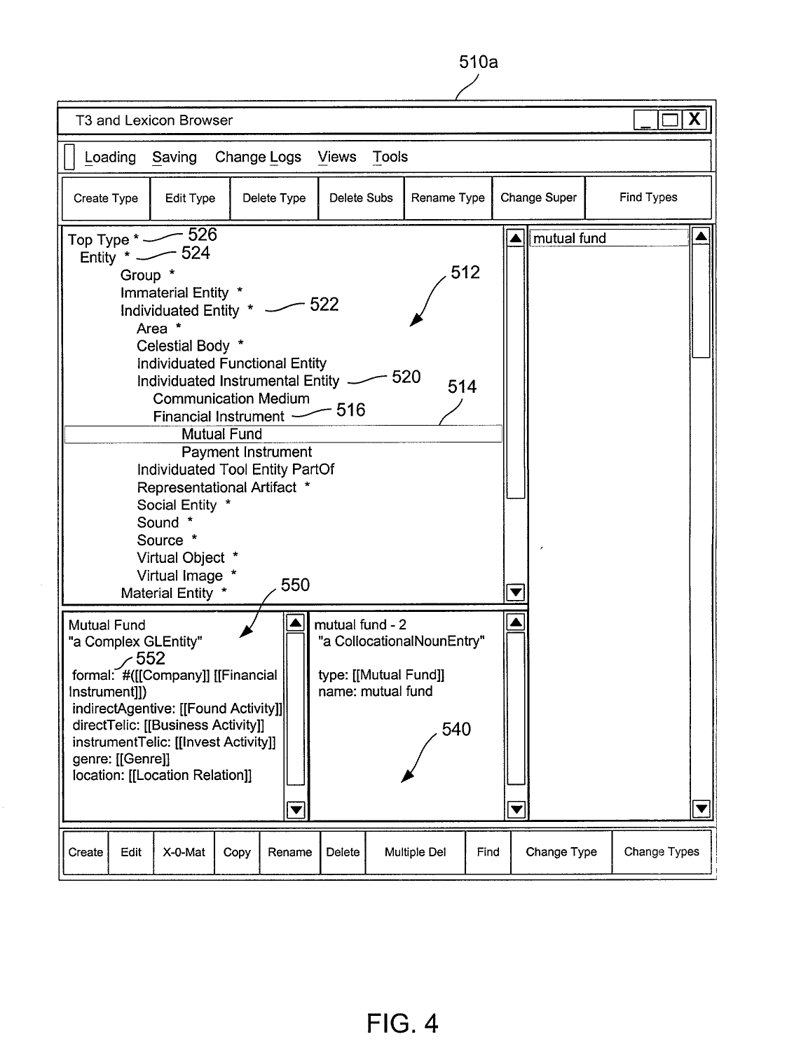

FIG. 4 illustrates an example of a complex entity of an embodiment of the present invention. FIG. 4 shows a window 510a of the TS and Lexicon Browser tool. There are three sub-windows of interest. A type tree window 512 showing the GLType tree, a lexical entry window 540 showing the lexical entry “mutual fund” 538, and a detailed type window 550 showing a complex type for [[Mutual Fund]] 542. From the type tree window, 20 “Mutual Fund” 514 is a subtype of “Financial Instrument” 516 which is a subtype of Individuated Instrumental Entity 520, which is subtype of Individuated Entity 522, which is a subtype of Entity 524, and which is a subtype of TopType 526.

While typically the lexical unit is a single word, it can be more than one word as in this case where the lexical unit is “mutual fund.” Note mutual fund is more than concatenation of two meanings “mutual” and “fund,” but its meaning includes an investment company performing some function. The values of formal 552 in the detailed type window 550 show that “Mutual Fund” has two supertypes “Company,” which is the priority supertype and “Financial Instrument” which is the default supertype.

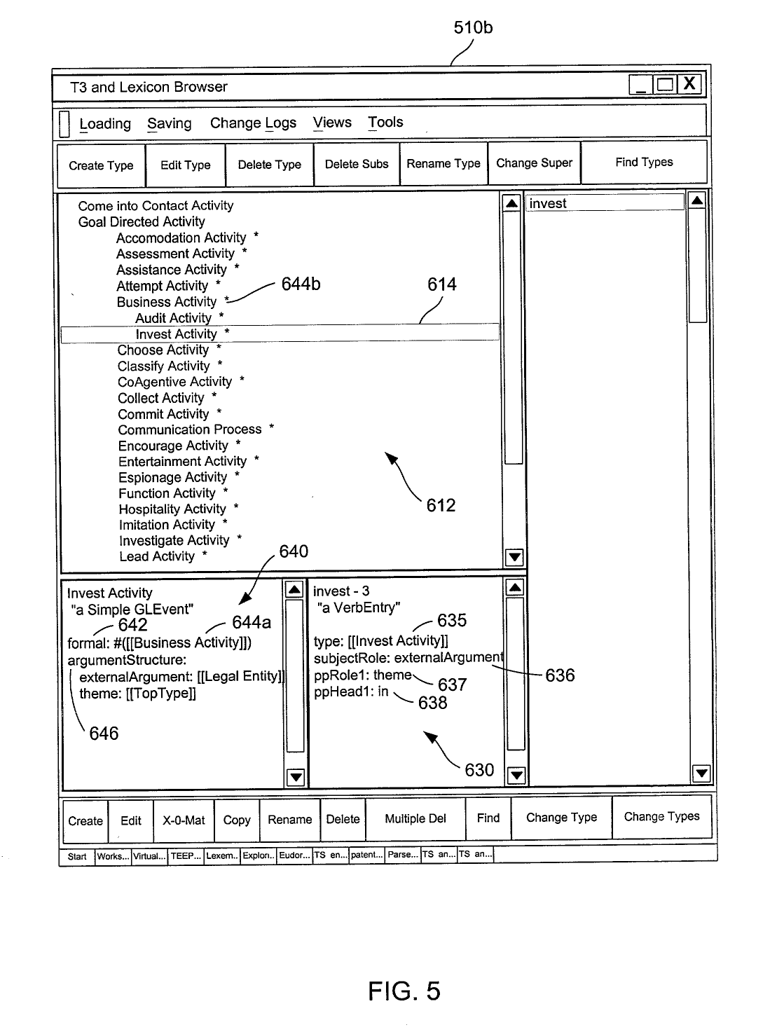

FIG. 5 illustrates an example of a simple event, for example verb, of an embodiment of the present invention. FIG. 5 shows a window 510b of the TS and Lexicon Browser tool. There are three sub-windows of interest. A type tree window 612 showing the GLType tree and the “Invest Activity” selection 614, a lexical entry window 630 showing the lexical entry “invest” 620 and a detailed type window 640 showing a simple type for “Invest Activity” 635. The formal qualia 642 in the detailed type window 640 show a supertype of Business Activity 644a which corresponds to the entry Business Activity 644b in the type tree window 612.

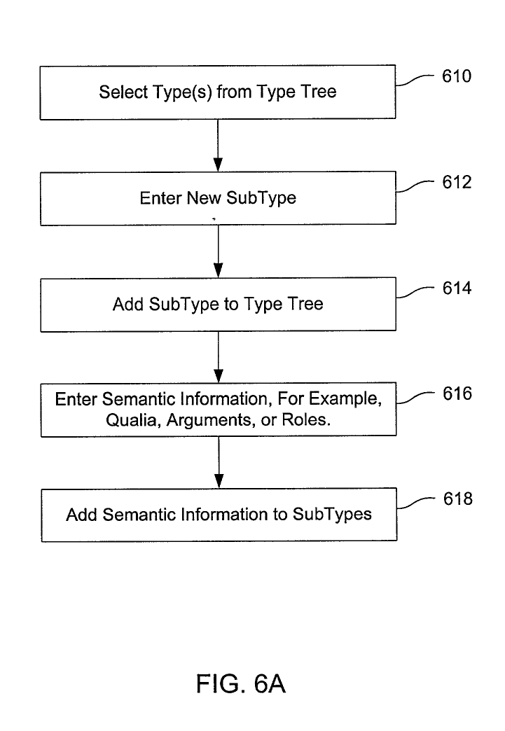

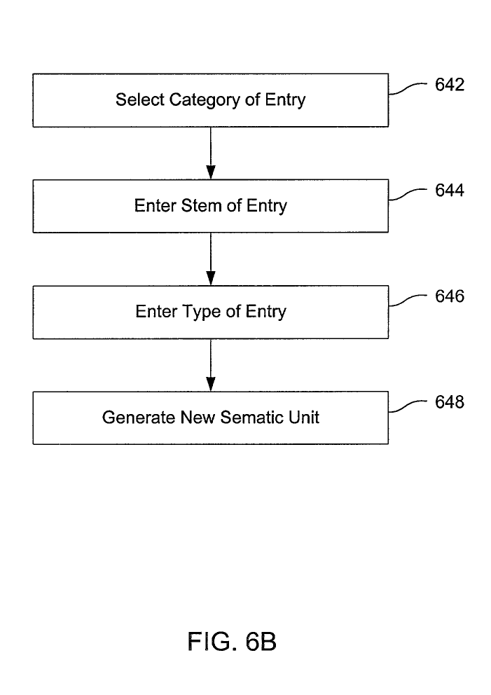

FIG. 6a has a block diagram illustrating the creation of a new type in one embodiment of the present invention. The types are maintained in the type system 232 of FIG. 1. At step 610 the user selects a type from the type tree as shown, for example, in FIG. 3 or in window panel 512 in FIG. 4. The user then enters a new subtype based on the selected type(s) (step 612). At step 614 the subtype is added to the type tree. At step 616 the user then enters semantic information, for example, qualia, arguments, or roles, and the semantic information is added to the new subtype ( step 618). The steps described above need not be done in the order given and are shown as only one example of a series of steps that may be taken. For example, in another embodiment, step 616 may be done before step 614 or in yet another embodiment, step 614 may be done concurrently with step 616.

FIG. 6b the has a block diagram illustrating the creation of a new semantic lexical item in an embodiment of the present invention. The semantic lexical entries may be maintained in a user or domain specific database. At step 642 the user selects the category, for example, grammatical part of speech, for the input or entry. The user enters the stem (i.e., lexical entry) for the entry (step 644). In another embodiment the stem may be selected automatically for the entry. And then the user enters the type of the entry (step 646). A new lexical semantic unit, including category and type information, is generated and associated with the lexical entry or stem. An example of a created lexical semantic unit is shown in the panel 540 of window 510a (FIG. 4) for lexical entry, i.e., stem, “mutual fund.” Another example is in panel 630 of window 510b (FIG. 5) for lexical entry “invest.” The steps described above need not be done in the order given and are shown as only one example of a series of steps that may be taken. For example, in another embodiment, step 644 may be done before step 642 or in yet another embodiment, step 644 may be done concurrently with step 646.

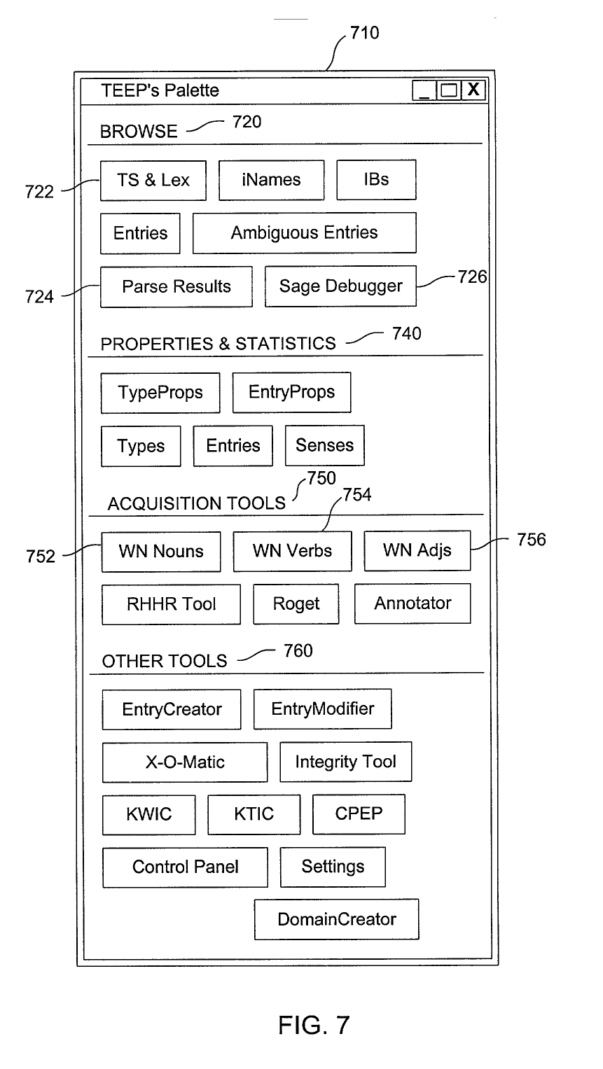

FIG. 7 illustrates an example of a tool palette of an embodiment of the present invention. The tool palette 710 is the is one of the initial interfaces to the computer software tools for acquiring and maintaining the natural language information in the computer storage system, for example database. And the tool palette 710 serves as a “table of contents” of the available tools. The tool palette 710 includes a browser section 720, a properties and 30 statistics section 740, an acquisition tools section 750 and an other tools section 760. In the Browser section 720 there are selections which include running a “TS & Lex” tool 722, a “Parse Results” tool 724 and a “Sage Debugger” tool 726. In the acquisition tools section 750 there are selections which include running a “WordNet (WN) Noun” tool 752 and a “WordNet (WN) Verbs” tool 754. Where “WordNet” includes synonym sets, and is produced by the Cognitive Science Laboratory, Princeton University, Princeton, NJ (http://www.cogsci.princeton.edu/˜wn/). “WordNet” provides noun and verb synonyms which allow additional words and their meanings to be added.

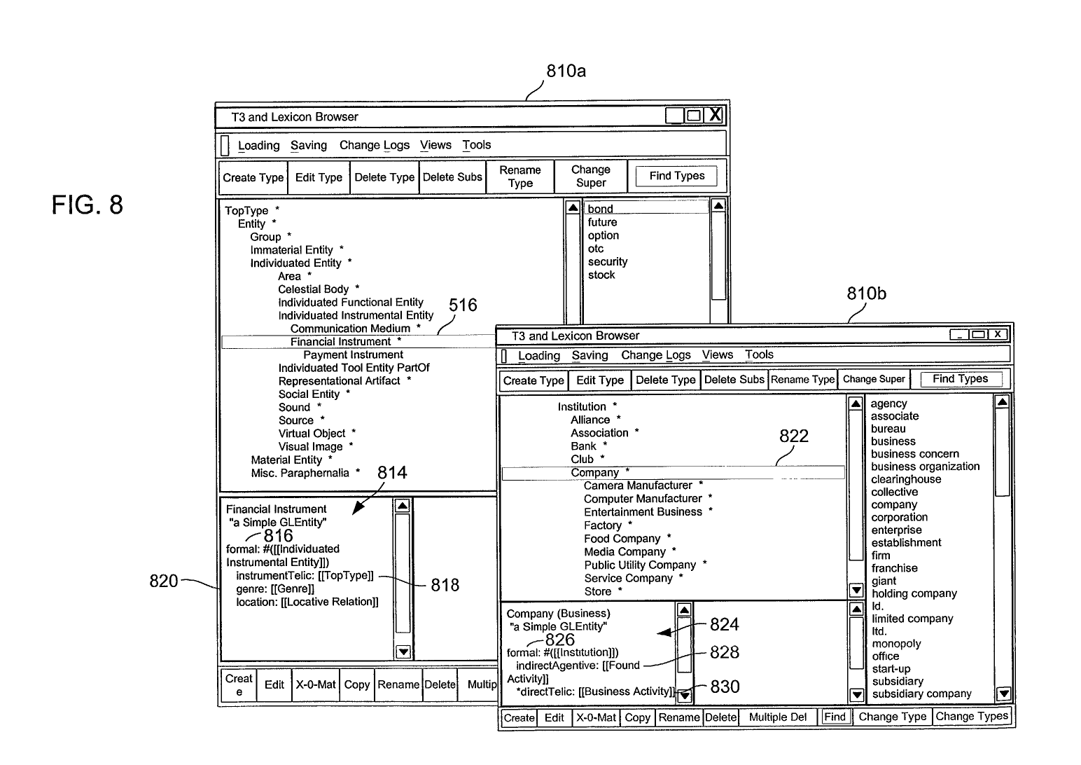

FIG. 8 illustrates an example of a using multiple inheritance to create a new type in an embodiment of the present invention. FIG. 8 has two TS and Lexicon Browser windows 810a and 810b. A TS and Lexicon Browser window may be started by the TS and Lexicon Browser button 722 on Palette 710 in FIG. 7. Window 810a has type “Financial Instrument” 516, which is given in more detail in panel 814. In panel 814 the quale “instrument Telic” is “TopType” 818. Window 810b has type “Company” 822 which is given in more detail in panel 824. In panel 824 the quale “indirectAgentive” is “Food Activity” 828 and “directTelic” is “Business Activity” 830.

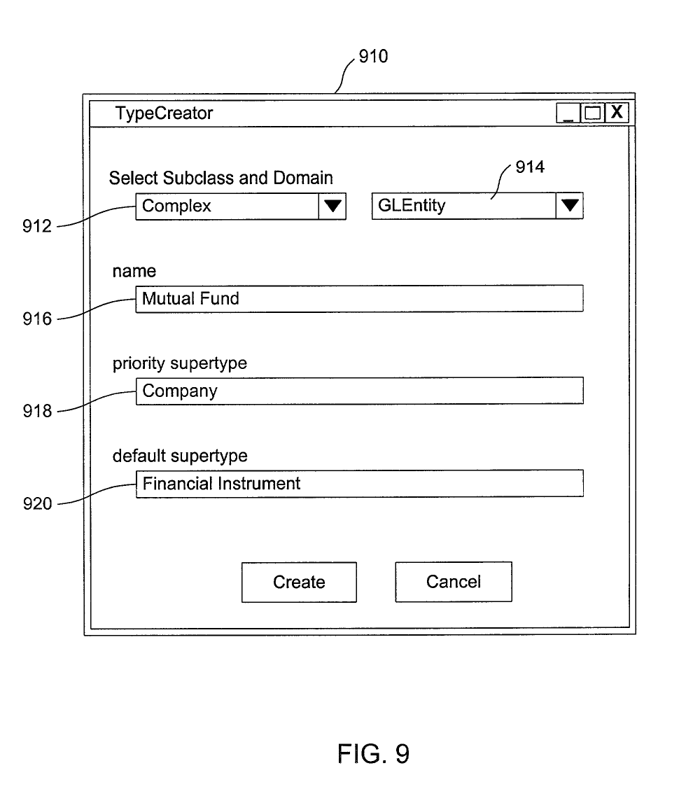

FIG. 9 illustrates one instance of a type creator window for adding a type to the type tree in one embodiment of the present invention. In the type creator window 910, a new “Complex” 912, “GLEntity” 914 type with name “Mutual Fund” 916 is created. The two parent types are priority supertype “Company 918 and default supertype “Financial Instrument” 920.

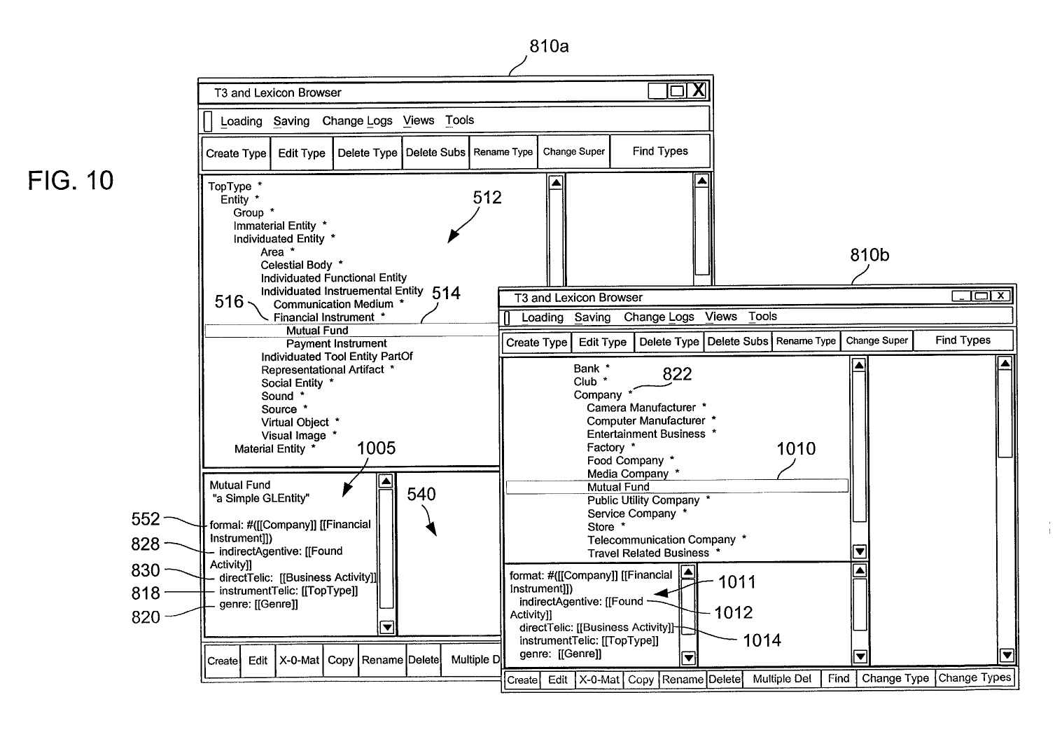

FIG. 10 shows the results of adding a complex entity type in one embodiment of the present invention. Window 810a in FIG. 10 is similar to window 510a in FIG. 4, in that panel 1005 has some of the same entries as panel 550. In FIG. 10 panel 512, “Mutual Fund” type 514 has been added as a subtype of “Financial instrument” 516. In panel 550 “Mutual Fund” has a formal quale of both “Company” and “Financial Instrument.” In addition the qualia of indirectAgentive 828 and directTelic 830 of window 810a has been added to panel 1005 from indirectAgentive 1012 and directTelic 1014 of panel 1011 of window 810b.

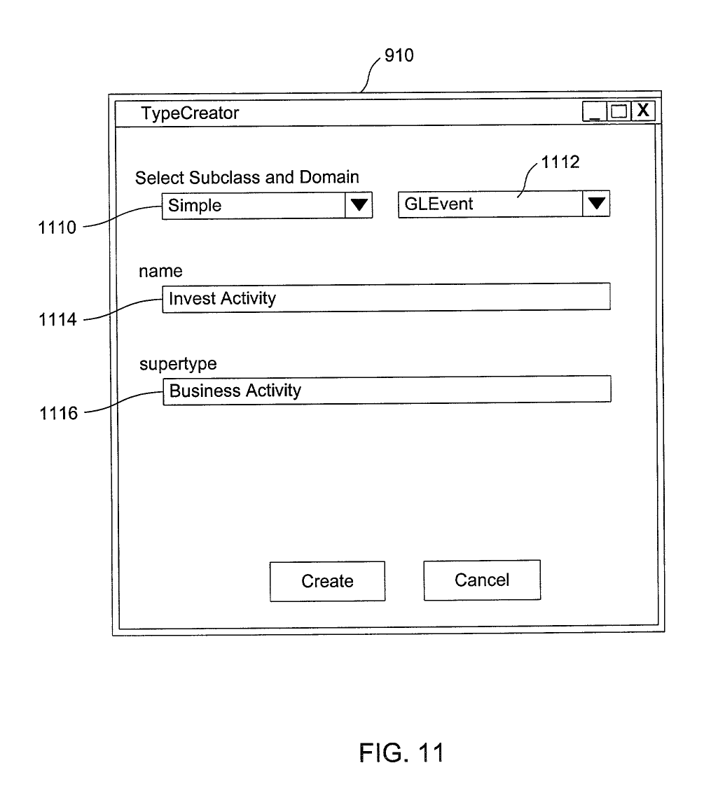

FIG. 11 shows an example of creating a simple type of an embodiment of the present invention. The type creator 910 in FIG. 11 selects a “Simple” 1100 “GLEvent” type 1112 with a name 1140 of “Invest Activity,” and a parent type of “Business Activity” 1116.

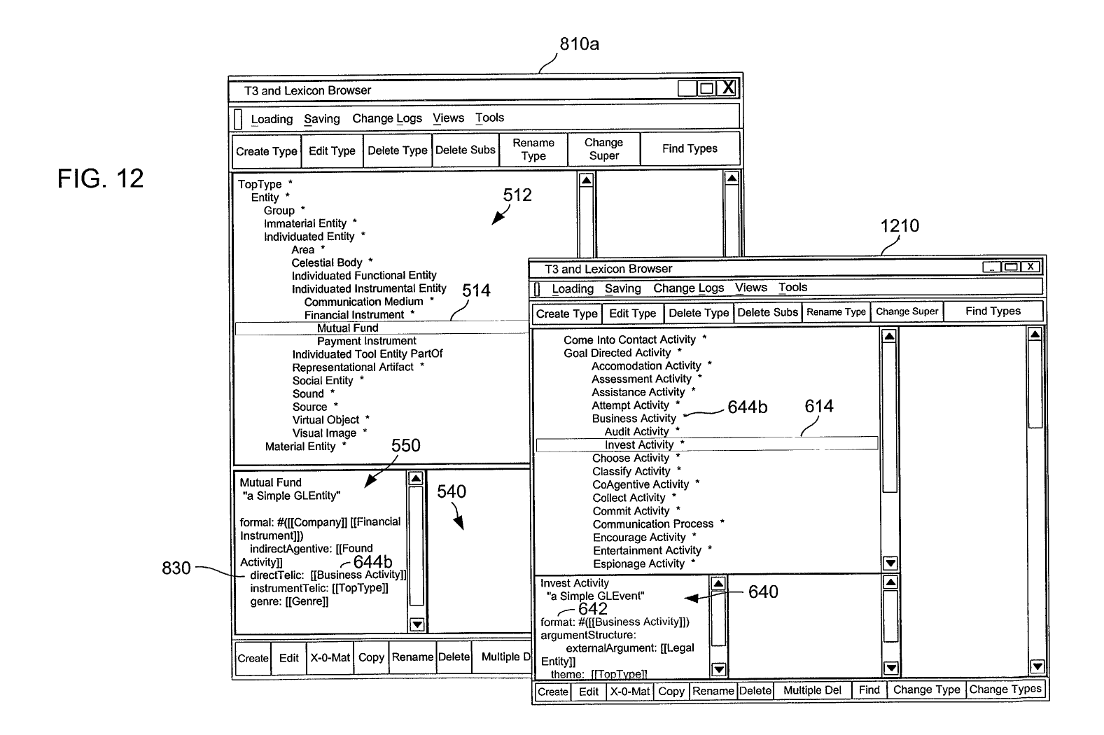

FIG. 12 shows the results of adding a simple entity type in one embodiment of the present invention. Window 1210 in FIG. 12 is similar to window 510b in FIG. 5. Panels 640 in both FIG. 12 and FIG. 5 are the same. Thus the type “Invest Activity” 614 has been created with parent “Business Activity” 644b. Note that “Business Activity” 644b is a type for the directTelic 830 of “Mutual Fund” in panel 550 of window 810a.

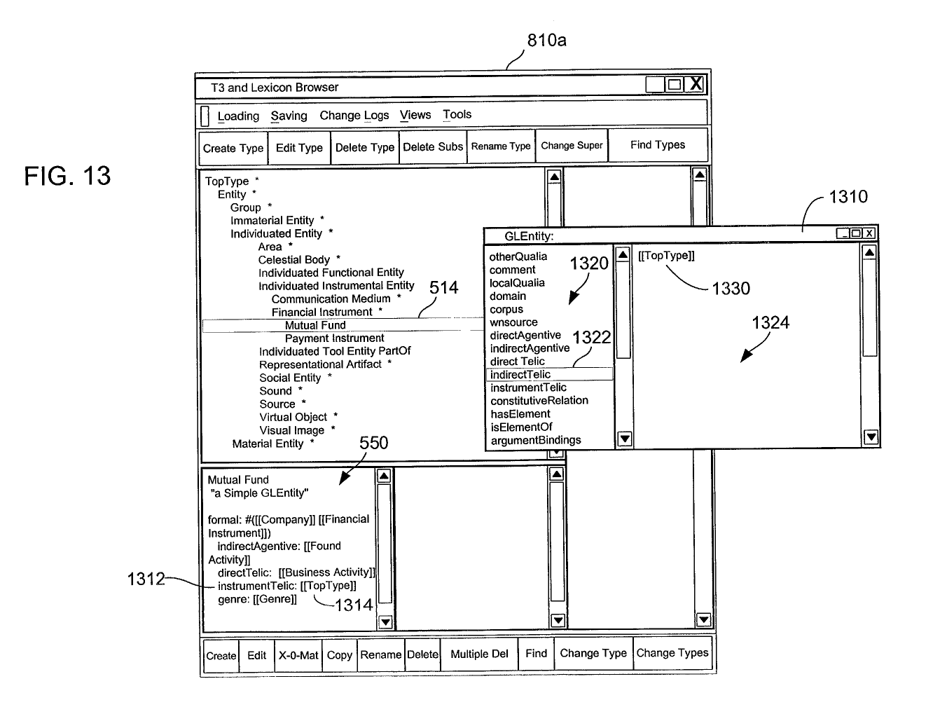

FIG. 13 illustrates the process of modifying a type characteristic, for example, quale, of an embodiment of the present invention. In FIG. 13 in panel 550, “instrumentTelic” 1312 has “TopType” 1314. To modify “instrumentTelic,” GLEntity window 1310 has a panel 1320 with a plurality of GLEntity characteristics, for example, “instrumentTelic” 1322. “TopType” 1324 in window 1310 is then modified to type “InvestActivity.

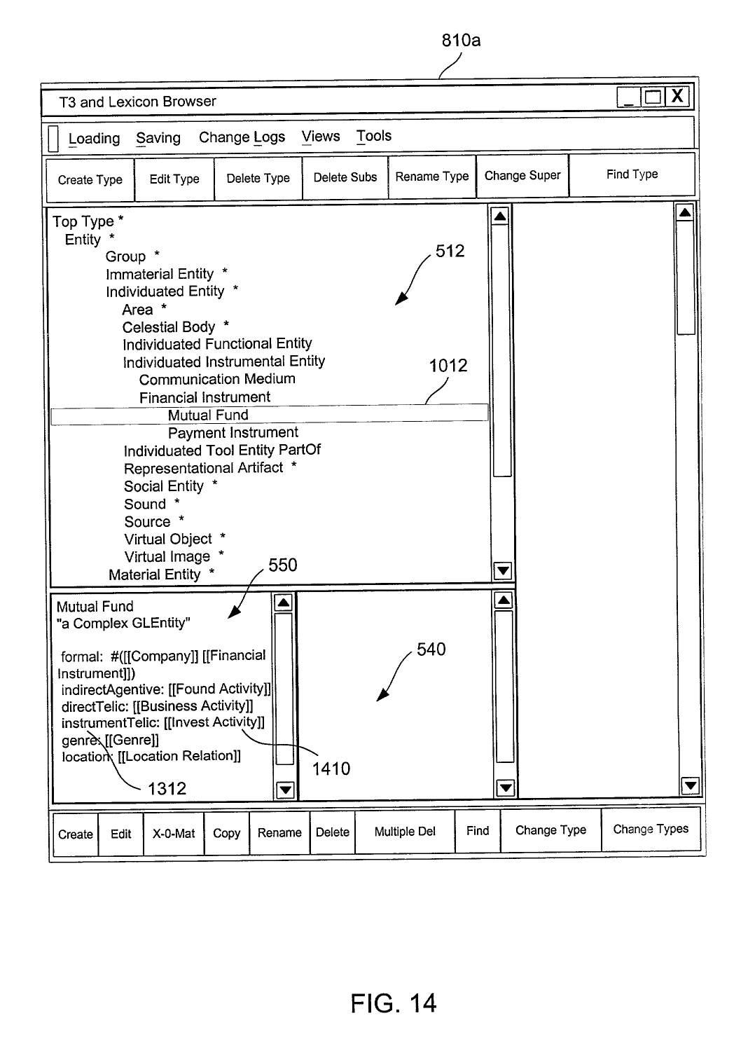

FIG. 14 illustrates the results of modifying a characteristic of FIG. 13. In FIG. 14 “instrumentTelic” 1312 has been changed from “TopType” to “Invest Activity” 1410.

Either in conjunction with or separately from the creation of new types is associating semantic information with a lexical entry, in other words, creating a new lexical semantic unit as in FIG. 6B. First using FIG. 4 as an example for a noun (e.g., mutual fund), the process of FIG. 6B is used to create the information in panel 540 of FIG. 4. Next using FIG. 5 as an example of a verb (e.g., invest), the process of FIG. 6B is used to create the information in panel 630 of FIG. 5.

In the first example of adding an noun stem, “mutual fund,” a category may be first selected.

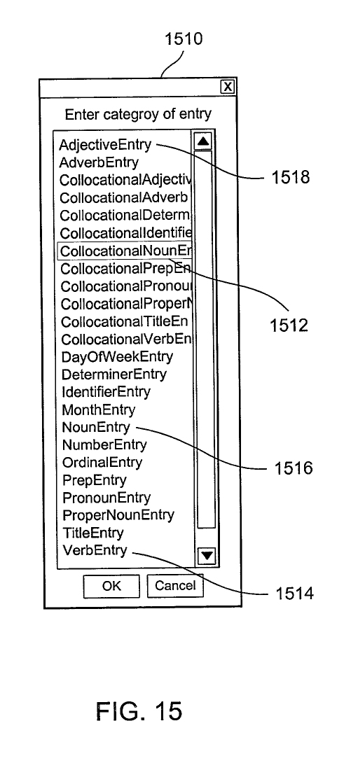

FIG. 15 shows the selection of a category for a lexical entry of one embodiment of the present invention. Window 1510 has a plurality of categories, “CollocationNounEntry” 1512 is selected for stem, “mutual fund,” VerbEntry 1514 is associated with a verb stem, for example, “invest,” and AdjectiveEntry 1518 is associated with an adjective stem, for example “French” as in “French food.”

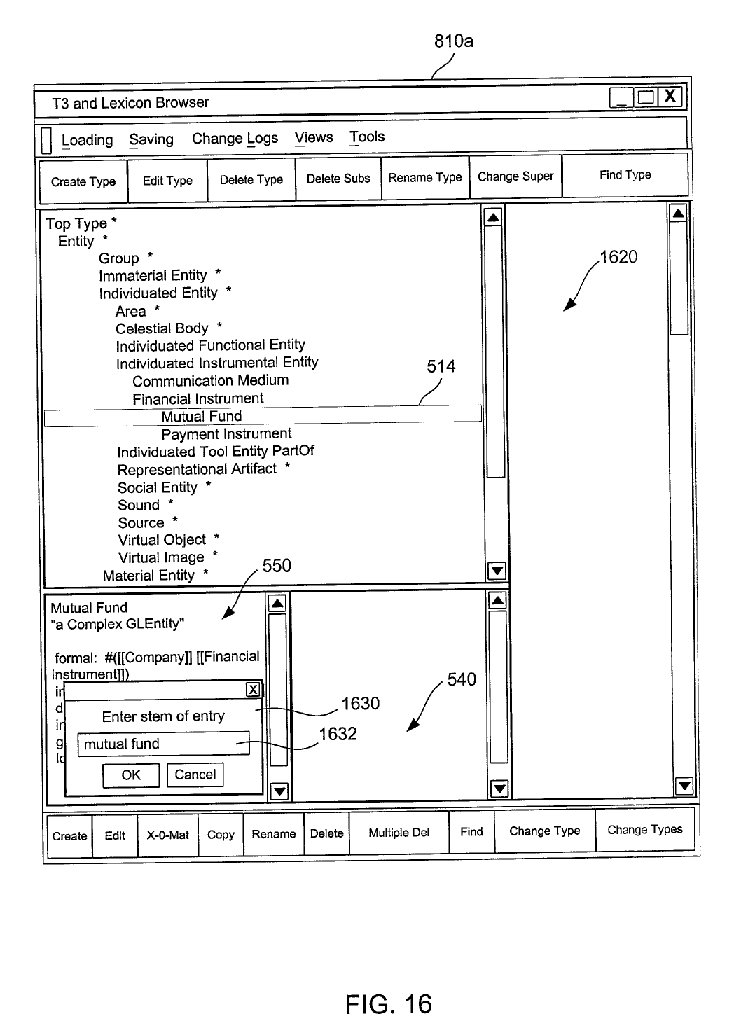

FIG. 16 shows the entry of a noun lexical entry of one embodiment of the present invention. The stem of the entry is “mutual fund,” which in this case is also the entry. In other examples the stem is looked up in a stem dictionary and may not be the same as the entry or input, for example, the stem of “invested” is “invest.” In FIG. 16 window 1630 shows the input of “mutual fund” 1632 for the lexical entry. Next a similar window (not shown) is used to enter the type of the lexical entry in this case, “Mutual Fund,” which should correspond to a type in the type tree, in this case 514. And in this example the head of the stem is entered as a number “2,” indicating that the word “fund” is the head of “mutual fund.”

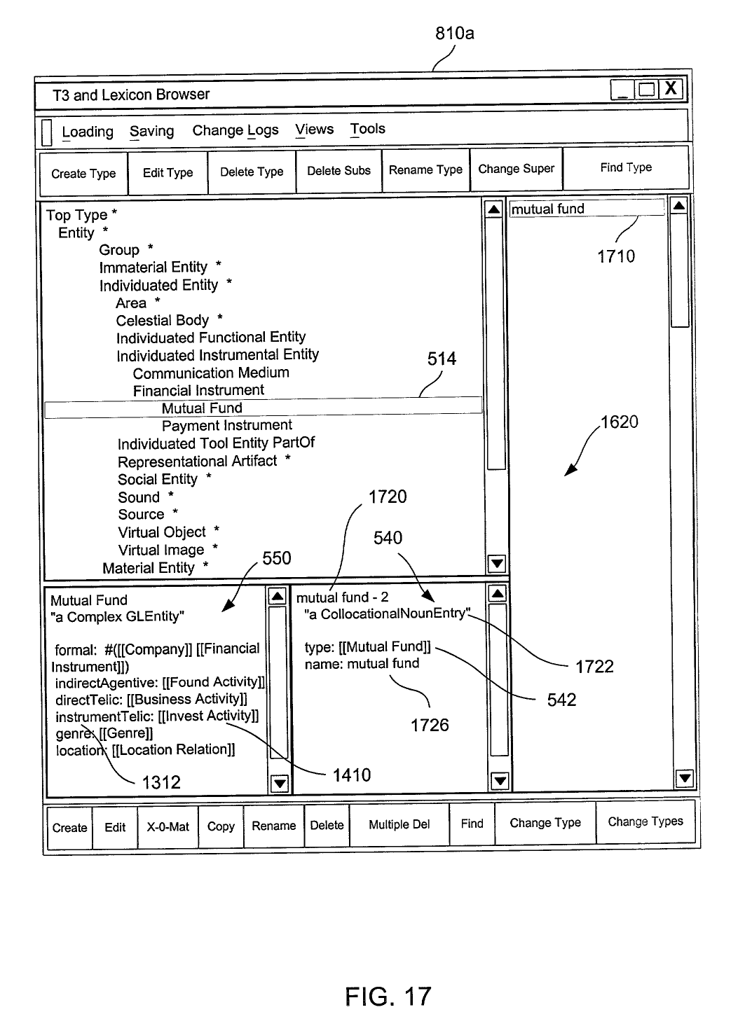

FIG. 17 shows a new lexical semantic unit created for the stem of FIG. 16 of one embodiment of the present invention. Panel 540a of window 810 matches panel 540 in FIG. 4. Stem “mutual fund” 1720 is a “CollocationalNounEntry” 1722 with a type “Mutual Fund” 542 and a name “mutual fund” 1726. The information associated with type “Mutual Fund” 542 is shown in panel 550. In addition stem “mutual fund” 1710 is shown in panel 1620.

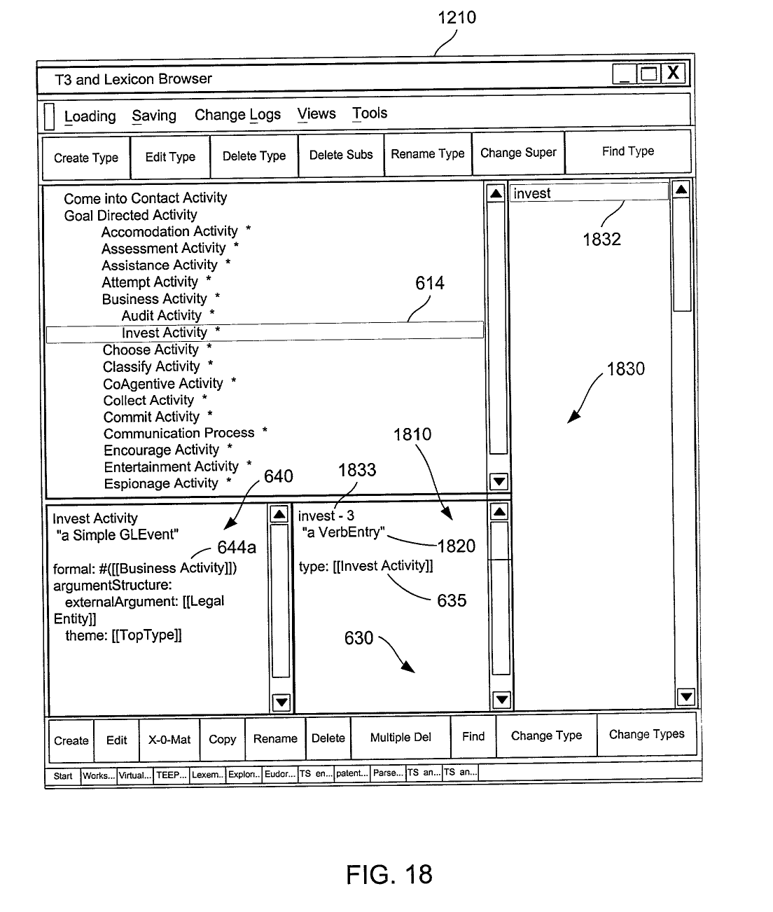

FIG. 18 shows the entry of a stem for a verb entry of one embodiment of the present invention. The procedure given in FIG. 6B is followed, first with selecting “VerbEntry” 1514 as the category in FIG. 15. Next the stem “invest” 1832 is chosen, followed by the selection of “Invest Activity” 635 for type. Thus the results are shown in panel 1810 and panel 1830.

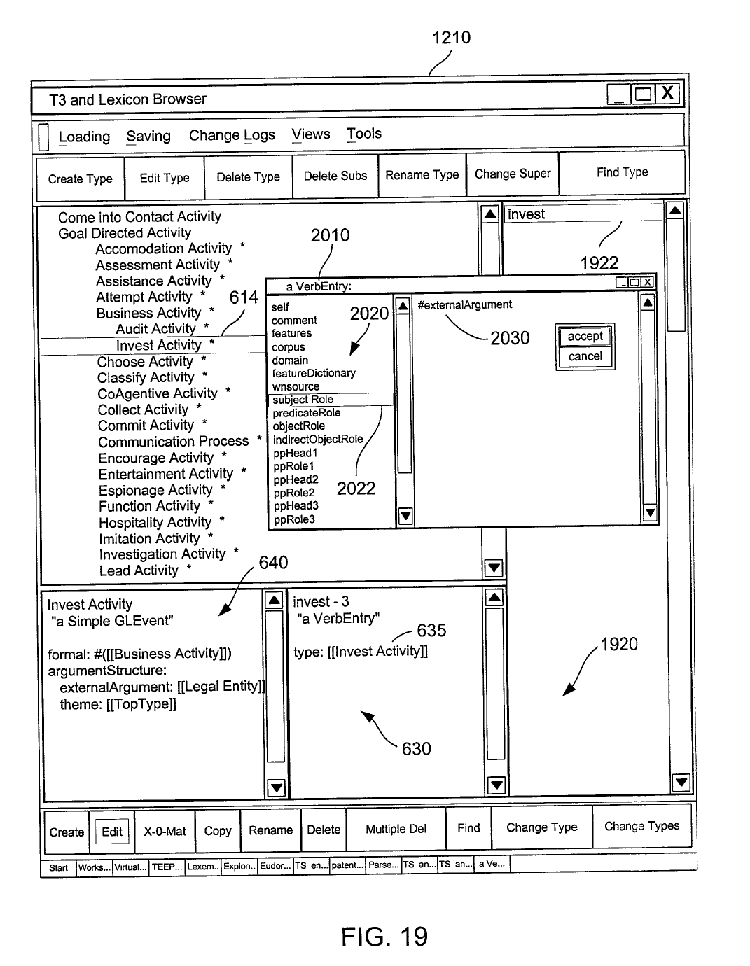

FIG. 19 illustrates the addition of VerbEntry characteristics to a verb stem of an embodiment of the present invention. Panel 630 has type “Invest Activity” 635. Additional characteristics may be added to VerbEntry window 2010, where panel to 2020 is a list of various VerbEntry characteristics that may be added. In this case subjectRole 2022 may be added with value “#extemalArgument” 2030 (636 in FIG. 5). Also added may be ppRole1 with value “theme” 637 (FIG. 5) and ppHead1 with value “in” 638 (FIG. 5). Thus the information in panel 630 of FIG. 5 for “invest” is generated.

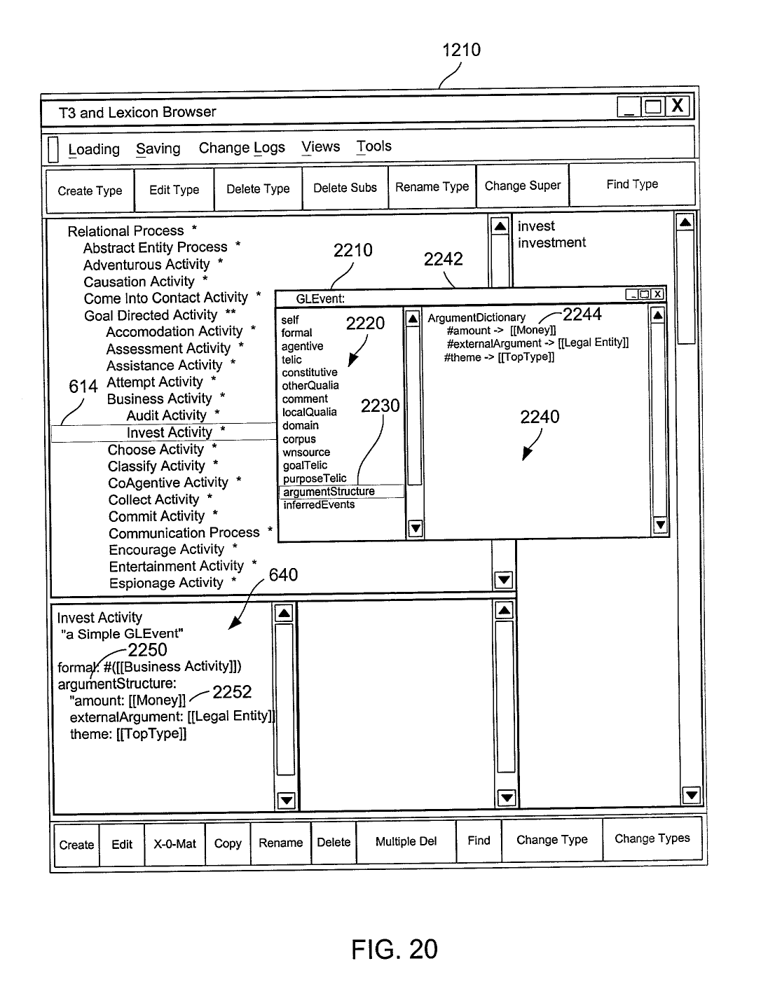

FIG. 20 illustrates modifying the argument structure of an Event of an embodiment of the present invention. In FIG. 20 the argument structure 646 of FIG. 5 may be modified by using GLEvent window 2210. In window 2210 the first panel 2220 has a list of various GLEvent characteristics, for example, argumentStructure 2230; argumentStructure 2230 may be modified in adjacent panel 2240 by adding, for example, #amount associated with “Money” 2244. This argument element corresponds to “amount:[[Money]]” 2252 in panel 640.

The procedure of FIG. 6B be may also be used to add an adjective category entry, for example, “French food.” Where the AdjectiveEntry 1518 of FIG. 15 is first selected. Next the stem “French” is entered with type “France.”

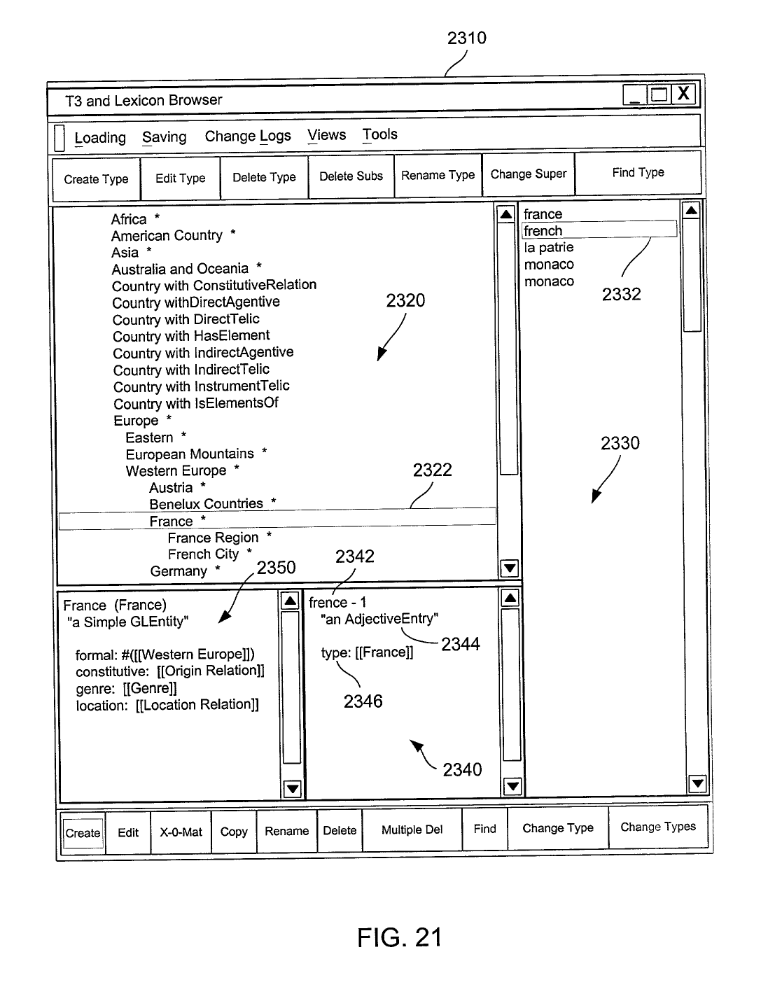

FIG. 21 shows the results of semantic information associated with a stem of an adjective entry of an embodiment of the present invention. The stem “French” 2342 is an “AdjectiveEntry” 2344 of type “France” 2346.

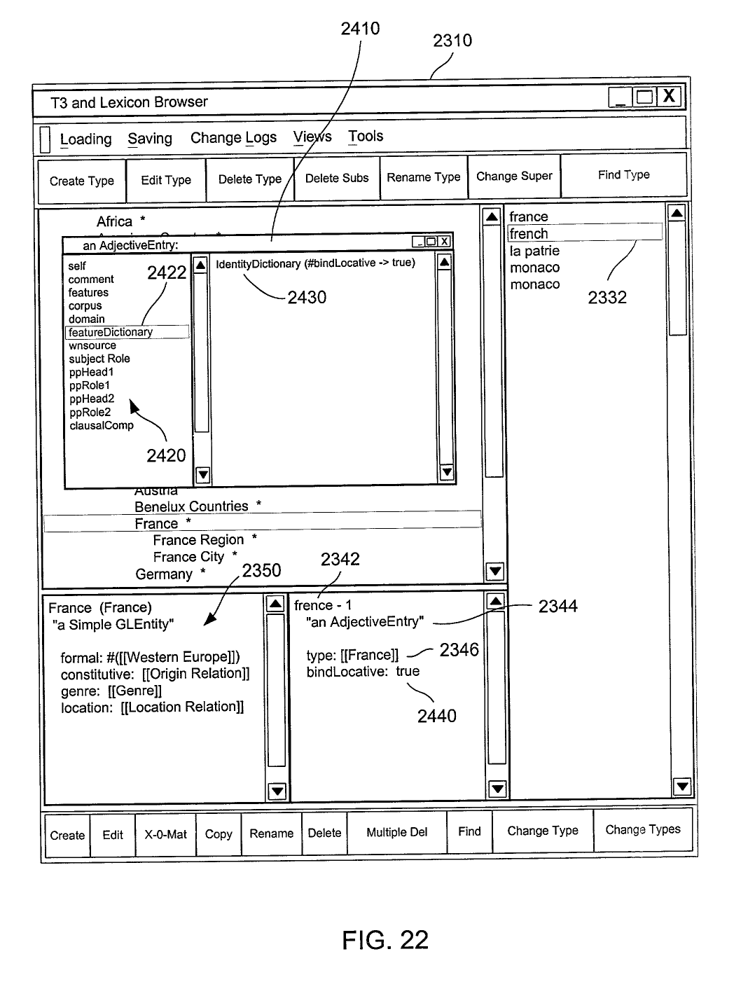

FIG. 22 illustrates adding AdjectiveEntry characteristics to the stem of an embodiment of the present invention. In FIG. 22 AdjectiveEntry window 2410 has panel 2420, which lists the AdjectiveEntry characteristics. In this example featuredDictionary 2422 is selected. In the featuredDictionary 2422 “#bindlocative” is a set to true 2430. This results in “bindlocative:true” 2440 being added to the “French” stem 2342.

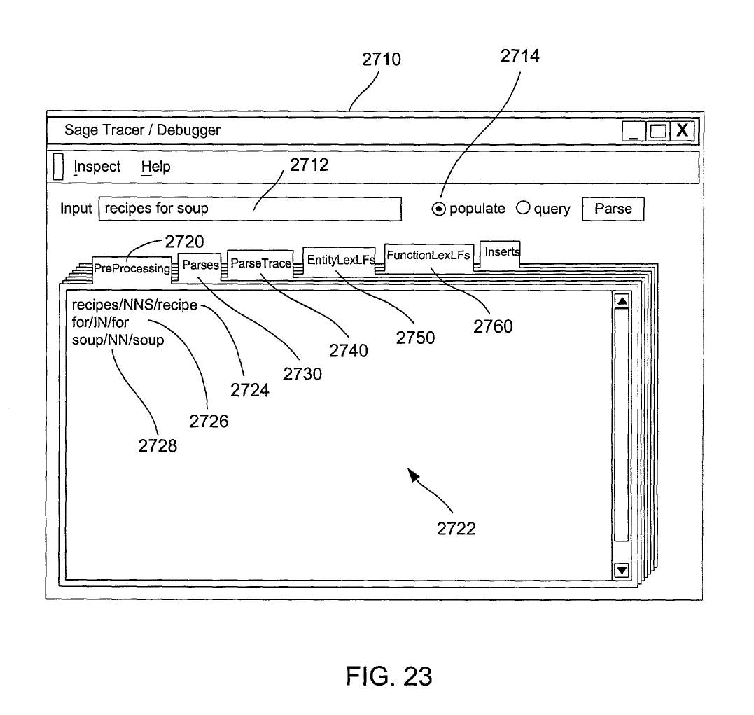

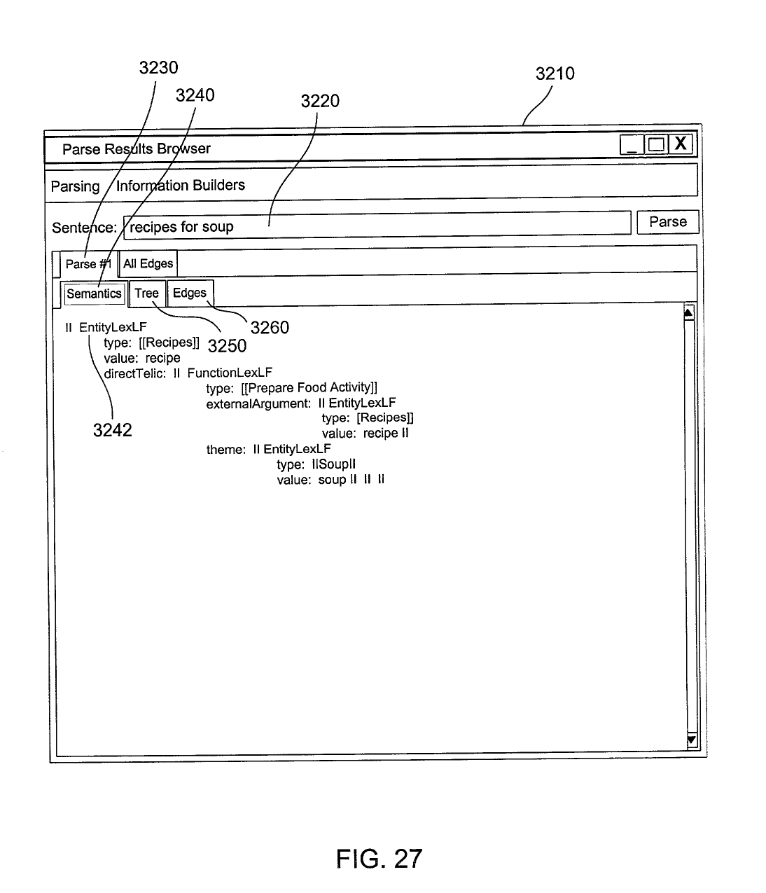

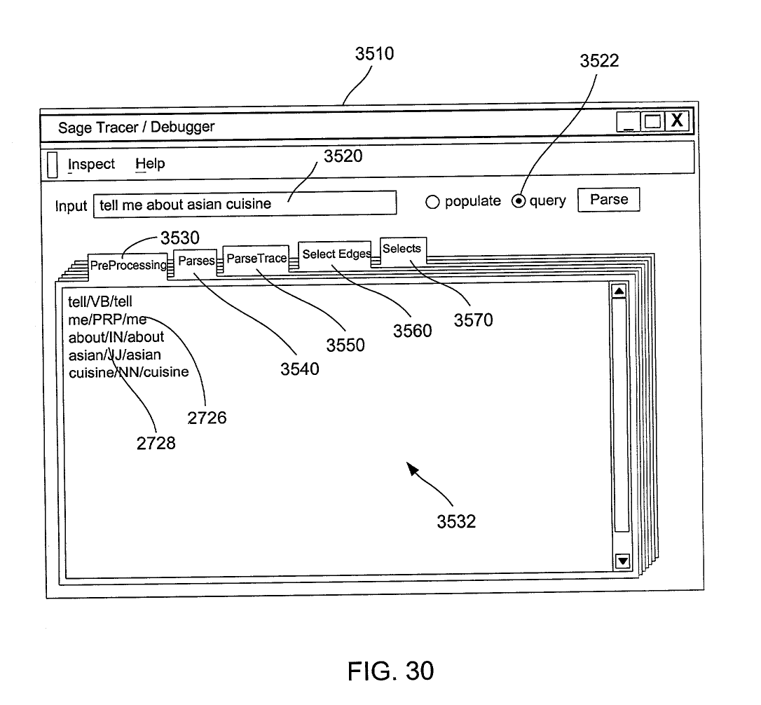

FIGS. 23 to 26 illustrate the use of the Sage Tracer/Debugger 726 (FIG. 7) in the populate mode for an example utterance, “recipes for soup,” for one embodiment of the present invention. FIGS. 27 to 29 illustrate the Parse Results Browser 724 (FIG. 7) for the same utterance “recipes for soup,” for one embodiment of the present invention. And FIGS. 30-32 illustrate the use of the Sage Tracer/Debugger 726 (FIG. 7) in the query mode for an example utterance, “tell me about Asian cuisine,” for one embodiment of the present invention.

FIG. 23 illustrates the pre-processing section of the tracer/debugger for an utterance of an embodiment of the present invention. FIG. 23 shows the tracer/debugger window 2710 having a preprocessing section 2720, a parses section 2730, a parses trace section 2740, and EntityLexLF section 2750 and a FunctionLexLF section 2760. The selection “populate” 2714 means that the tracer/debugger 2710 is in the database populate mode. The utterances or input, “recipes for soup” 2712 is analyzed. In the preprocessing section 2720 stemmed, tagged results, 2724, 2726, and 2728 are shown for the utterance 2712.

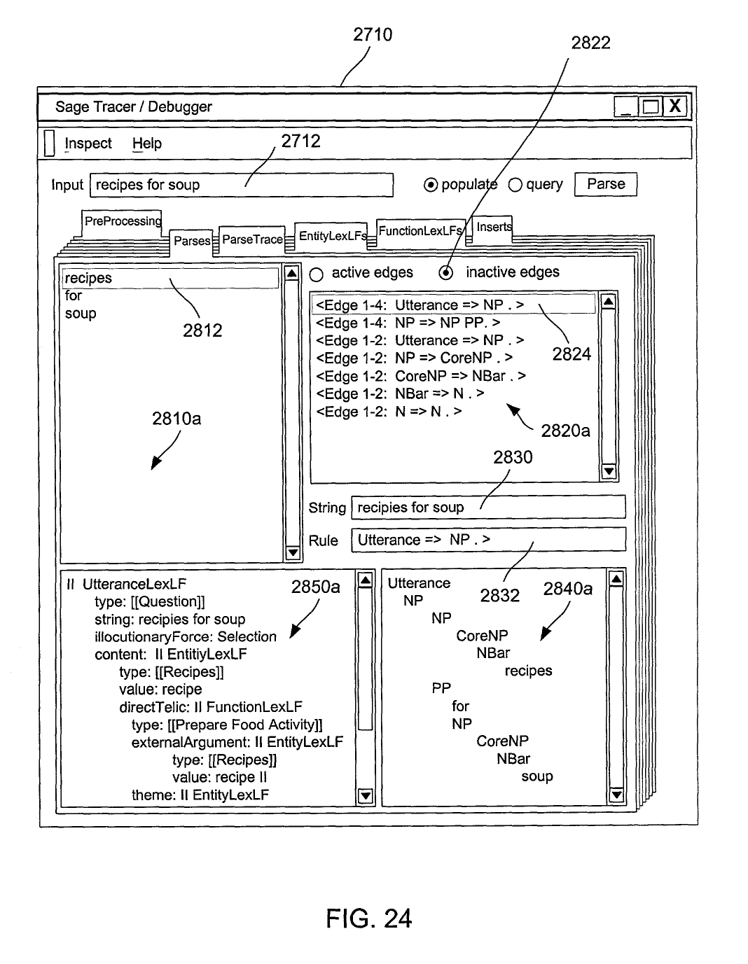

FIG. 24 illustrates the parses section of the tracer/debugger for one word of an utterance of an embodiment of the present invention. In panel 2810a the noun “recipes” 2812 is selected. FIG. 24 shows the inactivity edges 2822 in panel 2820a. Edge 1-4 2824 is selected in the window 2820a giving a parse tree in 2840a and a semantic structure given in 2850a.

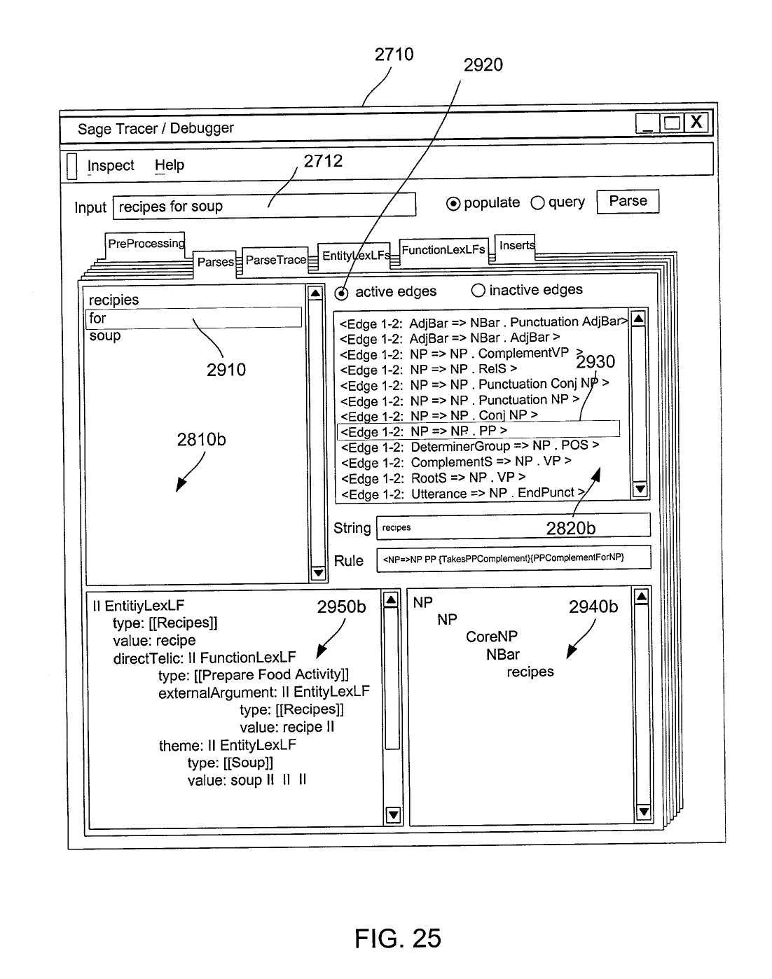

FIG. 25 illustrates the parses section of the tracer/debugger for another word of an utterance of an embodiment of the present invention. In panel 2810b the preposition “for” 2910 is selected. The active edges 2920 are shown in panel 2820b, where edge 1-2 2930 is selected. The parse tree is given in 2940b and a semantic structure is shown in 2950b.

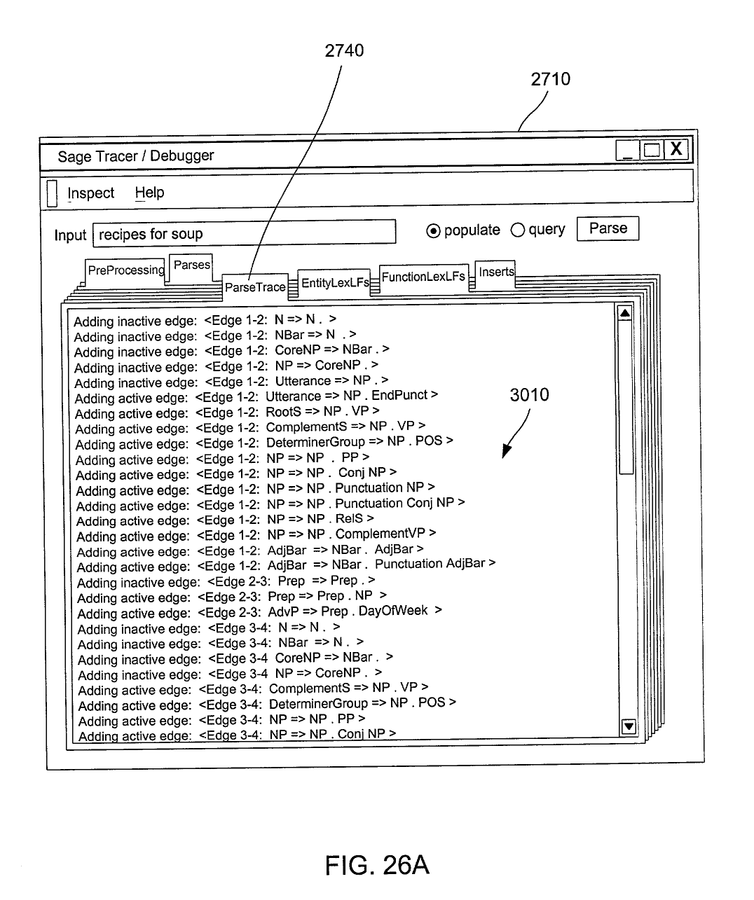

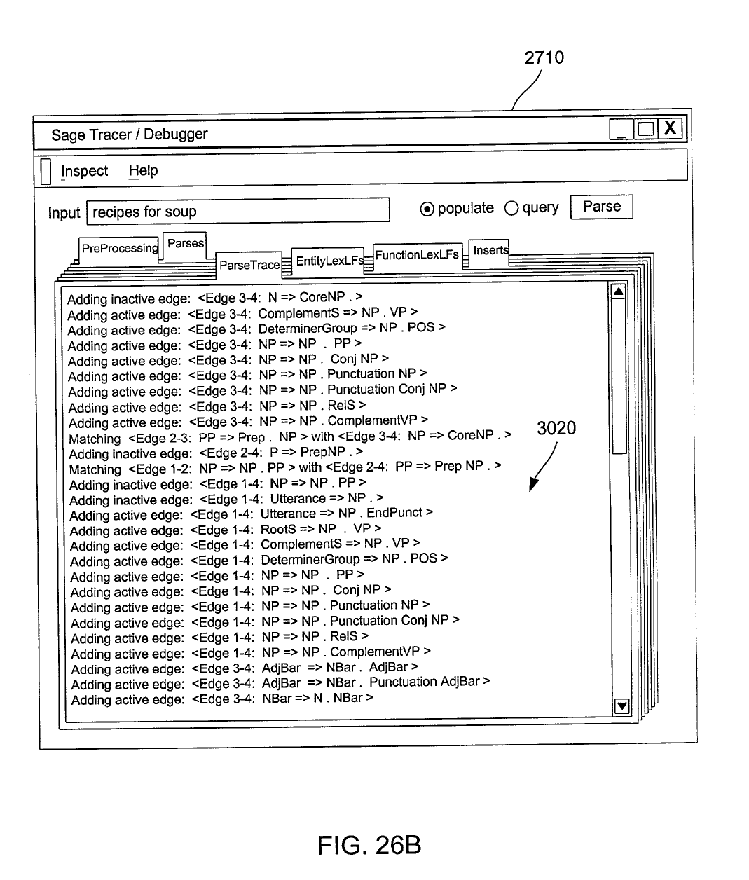

FIGS. 26a to 26b show the parse trace section for an example utterance “recipes for soup” of a specific embodiment of the present invention. This trace shows the edges as m they are created in the parse tree.

FIG. 27 illustrates a semantic item, EntityLexLF 3242, for an example utterance “recipes for soup” of a specific embodiment of the present invention. Further details are in U.S. Provisional Patent Application No. ______ in the names of James D. Pustejovsky, et al. titled,“Answering User Queries Using A Natural Language Method And System,” filed Aug. 28, 2000 (Attorney Docket No. 019497-000150US) which is herein incorporated by reference in its entirety.

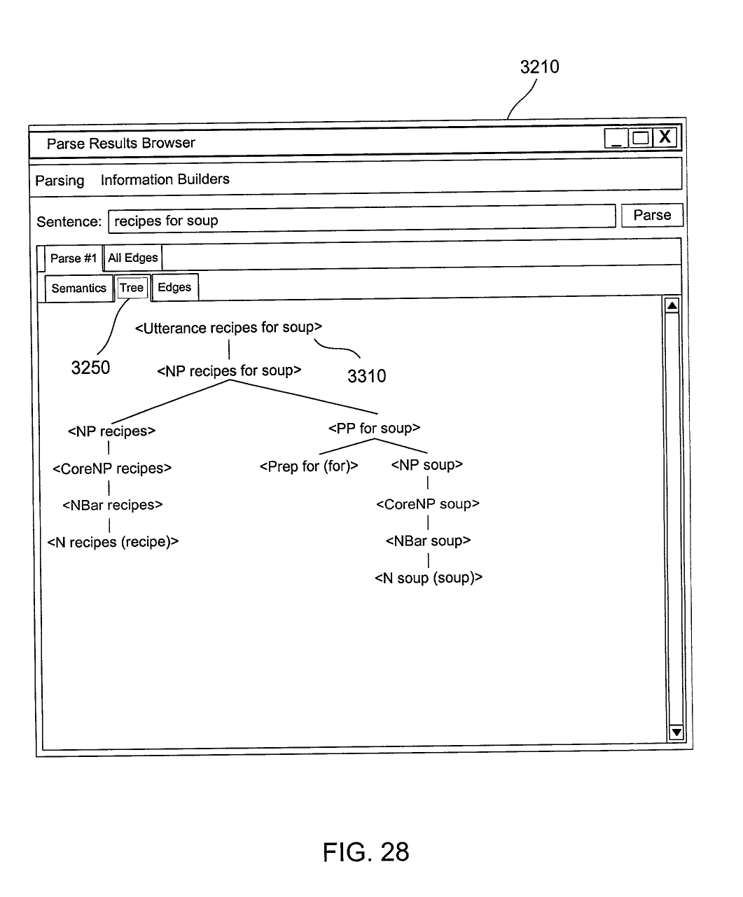

FIG. 28 illustrates a parse tree 3250 for an EntityLexLF 3242, for an example utterance “recipes for soup” of a specific embodiment of the present invention.

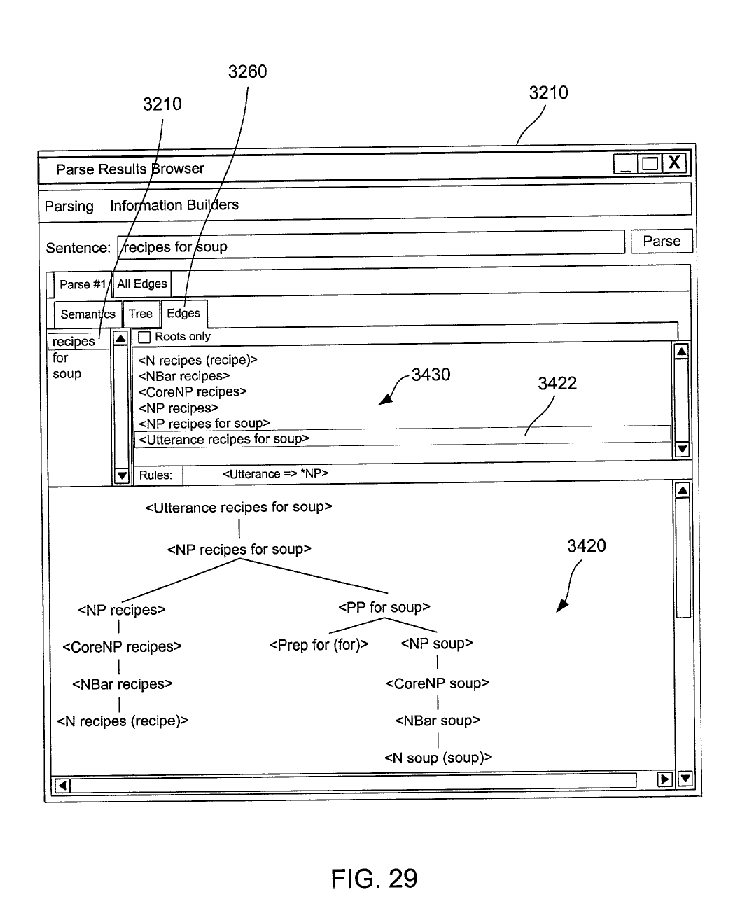

FIG. 29 illustrates edges in a parse tree for a word in an example utterance “recipes for soup” of a specific embodiment of the present invention. The selected word is “recipes” 3410, which gives the edges in panel 3420. The edge selection of “Utterance recipes for soup” 3422 gives the parse tree in panel 3430.

FIG. 30 illustrates a use of the tracer/debugger in the query a mode for a sample utterance of an embodiment of the present invention. The sample query is: “Tell me about Asian cuisine” 3520. The tracer/debugger in query mode 3522 has five sections: preprocessing 3530, parses 3540, parse trace 3550, selected edges 3560, and selects 3570. The preprocessing results after tokenizing, tagging, and stemming, are shown in panel 3532.

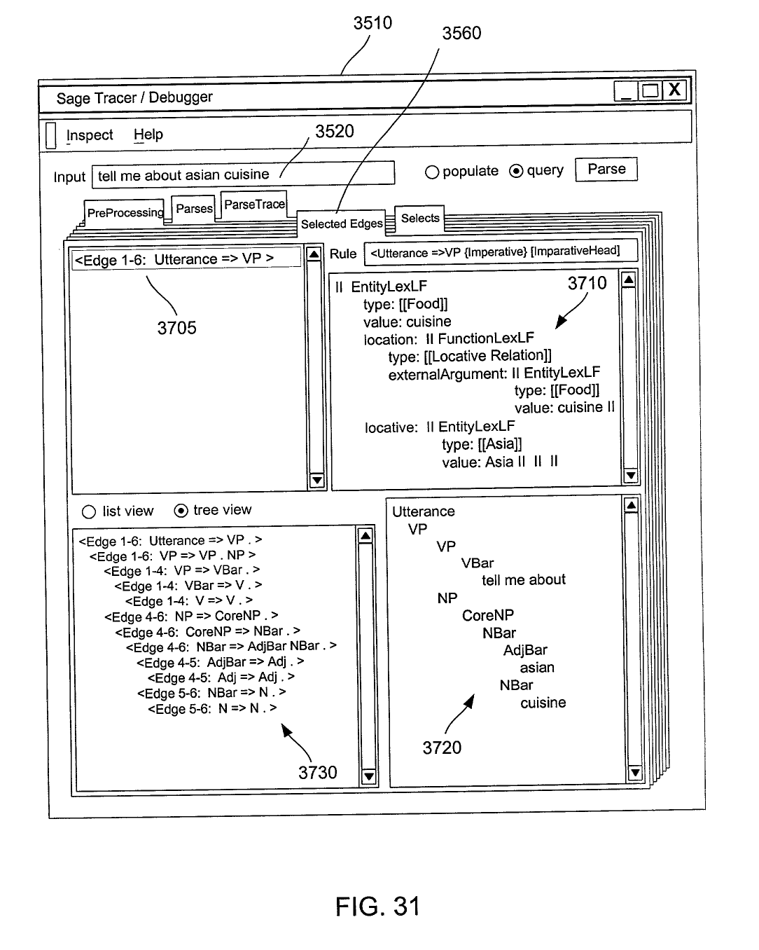

FIG. 31 illustrates the selected edges section of the tracer/debugger in query mode for an example utterance of an embodiment of the present invention. In FIG. 31 the top edge is given by Edge 1-6 “Utterance=>VP” 3705. The semantics selected by the system for the utterance 3705 is given in panel 3710. The selected parse tree is given in 3720 and the edges selected by the system to give the parse tree 3720 and semantics 3710 is shown in panel 3730.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. A method using a computer system for determining semantic information of a lexical unit, comprising one or more words, said method comprising:
receiving said lexical unit by said computer system;
determining a stem of said lexical unit;
determining a type of said lexical unit; and
generating semantic information associated with said lexical unit, wherein said semantic information is based on said stem and said type.

2. The method of claim 1 wherein said type is selected from a group consisting of entity or event.

3. The method of claim 2 wherein when said type comprises an entity type, said entity type is selected from a group consisting of simple or complex.

4. The method of claim 2 wherein when said type comprises an event type, said event type is selected from a group consisting of simple or complex.

5. A method for generating a semantic lexical item from an input, comprising one or more words, said method comprising:
receiving said lexical entry by a computer, said computer comprising a processor;
determining category information of said input;
determining a stem of said input;
determining a type of said input;
generating said semantic lexical item associated with said stem, wherein said semantic lexical item, comprises said type and said category information; and
storing said semantic lexical item in a storage system coupled to said processor.

6. The method of claim 5 wherein said type is selected from a group consisting of entity or event.

7. The method of claim 5 wherein said category includes information associated with a grammatical element.

8. The method of claim 7 wherein said grammatical element is selected from a group consisting of noun, verb, adjective, adverb, or pronoun.

9. A method for displaying a stage in the natural language compilation of an utterance, comprising one or more words, said method comprising:
receiving the utterance by a natural language system;
determining a semantic item associated with the utterance; and
displaying the semantic item.

10. The method of claim 9 wherein the semantic item comprises a syntactic-semantic composition.

11. The method of claim 9 further comprising displaying a parse tree associated with the utterance.
